(19) United States
(12) Patent Application Publication
(10) Pub. No.: US 2012/0103017 A1
(43) Pub. Date: May 3, 2012

(54) METHOD FOR PRODUCING A HIGHLY PURE QUARTZ GRANULATE

(76) Inventor: Frank-Peter LUDWIG, Erfurt (DE)

(21) Appl. No.: 13/346,095

(22) Filed: Jan. 9, 2012

Related U.S. Application Data
(63) Continuation of application No. PCT/EP2010/059215, filed on Jun. 29, 2010.

(30) Foreign Application Priority Data
Jul. 9, 2009 (DE) DE10 2009032297.3

(51) Int. Cl. C03B 19/10

(52) U.S. Cl. 65/21.5

(57) ABSTRACT

A method for producing a highly pure quartz granulate is provided by means of which a highly pure quartz granulate can be produced from a natural quartz raw material via the steps of: washing a natural quartz raw material in the form of coarsely crushed pieces; mechanical comminution of the pre-crushed pieces; further comminution of the pieces to a grain size of less than 0.5 mm via high-voltage discharge pulses; flotation for separating out foreign minerals; and chemical treatment for further depletion of foreign elements.

This nonprovisional application is a continuation of International Application No. PCT/EP2010/059215, which was filed on Jun. 29, 2010, and which claims priority to German Patent Application No. DE 10 2009 032297.3, which was filed in Germany on Jul. 9, 2009, and which are both herein incorporated by reference.

### BACKGROUND OF THE INVENTION

1. Field of the Invention

The invention relates to a method for producing a highly pure quartz granulate from natural quartz raw materials. Natural quartz raw materials, such as rock crystal or vein quartz, can be processed by the method of the invention.

2. Description of the Background Art

Silicon and oxygen are the most common elements in the upper crust of the earth. They occur predominantly together in the form of silicates. In addition, they occur as more or less pure silicon dioxide, predominantly as quartz. Quartz occurs predominantly in the form of rock crystal (large monocrystals), vein quartz, or quartzite (polycrystalline structure) and as a component within polycrystalline rock (pegmatitic quartz). Rock crystal and vein quartz represent very pure silicon dioxide (>99%), whereas the quartz content in pegmatites can only be a few percentages.

In the processing of natural quartz raw material into highly pure quartz granulate, all elements apart from silicon and oxygen are regarded as foreign elements. The goal is the production of a granulate having 100% SiO₂ if possible. Today, highly pure granulates available on the market, which are produced from natural quartz, contain only a few mass ppm of foreign elements, predominantly Al, Ti, Fe, Ca, and alkali metals. The typical grain size of highly pure quartz granulates is 0.1 to 0.3 mm.

The foreign elements are present in natural quartz in following forms: as individual ions in the lattice of the quartz crystal or at lattice sites; as individual particles (granules) of foreign minerals, e.g., rutile, zirconium, and mica; as salts in aqueous solution in inclusions (filled hollow spaces) within the crystal, predominantly alkalis.

The goal during the processing of natural quartz raw material into highly pure quartz granulate is the most complete removal possible of all foreign elements.

The beneficiation of the aforementioned natural quartz raw materials into quartz granulates, which are used, e.g., in glass manufacture, is basically known from the conventional art. The following processing steps are known from the different classic beneficiation methods: mechanical comminution by means of crushers, mills, and similar devices; washing to remove coarse contaminants; flotation to separate foreign minerals; high gradient magnetic separation to separate foreign magnetic particles; acid leaching to remove foreign metals; and calcination (high-temperature treatment) to break up liquid- or gas-containing inclusions.

The East German patent publications DD 115 050 A1 and DD 136 259 A describe methods that use the following process steps for the production of highly pure quartz granulates: washing of a natural quartz raw material present in the form of coarsely pre-crushed pieces; mechanical comminution of the pre-crushed pieces; further comminution of the pieces to a grain size of less than 0.5 mm; and chemical treatment for further depletion of foreign elements. The yields achievable by this means are low, however.

The foreign elements can be removed from the quartz more or less completely by these treatment steps. A quartz granulate with a foreign element content of a few ppm can be produced from a raw quartz with a foreign element content of several 100 ppm. Nevertheless, the above-described beneficiation methods cannot be used with an equally good result for any quartz raw material. Often, the liquid- or gas-filled inclusions in particular cannot be completely opened, so that a certain content of foreign element is retained in the quartz granulate. For this reason, there are currently worldwide only very few deposits of natural quartz from which a highly pure granulate with few ppm's of foreign elements and particularly a content of alkali elements (Li, Na, K) of less than 1 ppm can be produced.

If the quartz granulate is to be used for the production of quartz glass, there is another quality problem with the natural raw material, apart from the foreign elements. The liquid- or gas-containing inclusions in the natural quartz lead to the formation of bubbles in the glass melt and thus reduce the quality of the glass. The most complete opening of all inclusions possible in the natural quartz is an important goal of beneficiation for this reason as well.

Russian Pat. No. RU 23 37 072 C1 describes a method for the production of highly pure quartz powder. In this case, the impurities in artificially grown crystals are removed by subjecting the quartz crystals to a thermal crushing after mechanical crushing in that they are heated to a temperature of 1000 to 1100° C. and then subjected to water cooling. Then, a mechanical grinding to a grain size of 0.1 to 0.28 mm occurs, as well as a magnetic separation process, a chemical treatment lasting 40 to 45 minutes in a mixture of 25 to 30% HCl and 9 to 11% HF, subsequent neutralization by washing with water, filtration, drying, and chlorination, lasting 25 to 30 minutes, at a temperature of 1200° C.

This method is suitable for processing artificially grown crystals that do not contain any liquid inclusions. Natural quartz raw materials cannot be processed thereby into highly pure quartz powder.

Further, it is also known from the conventional art to comminute solids by means of shock waves generated by high-voltage discharges. For example, WO 2008/017172 discloses fragmenting highly solid construction and composite materials by means of electrodynamic methods.

### SUMMARY OF THE INVENTION

It is therefore an object of the invention to provide a method with which a highly pure quartz granulate can be produced from a natural quartz raw material and in which the chemical purity of the granulate is significantly better than during the beneficiation of the same raw material by prior-art methods.

### DETAILED DESCRIPTION

In detail, the beneficiation method proceeds as follows: washing of the raw material in the form of coarsely pre-crushed pieces, preferably by high-pressure washing; mechanical comminution, for example, by a jaw crusher, preferably to a grain size of 20 to 30 mm; comminution by means of high-voltage discharge pulses to the target grain size of less than 0.5 mm and optionally classification; flotation to separate foreign minerals; acid leaching for further depletion of foreign elements, i.e., of acid-soluble metals.

An important advantage of the method is that a substantially improved product is formed in the case of the mentioned starting materials. The further comminution of the pieces by means of high-voltage discharge pulses to a grain size of less than 0.5 mm and the flotation to separate foreign minerals are particularly useful for this purpose.

An essential property of the shock wave comminution, which leads to its effectiveness in the claimed method, is the selectivity of the comminution. The key advantage is that the material is broken with a very high selectivity at phase boundaries within the material by means of the energy discharge of the shock waves, and not at some arbitrary place within the material.

Natural quartz material always contains more or less frequent, solid or liquid-gaseous inclusions of foreign elements.

The foreign elements in the solid or liquid-gaseous inclusions of the starting material have a negative impact on the chemical purity of the quartz granulate. The aim of the beneficiation of a natural quartz raw material is to remove the foreign elements as completely as possible and to achieve a purity of 100% SiO₂. To this end, the inclusions must be opened as completely as possible, to release the foreign substances present therein and to remove them from the granulate, or they must be brought at least to the surface of the quartz grains, so that they become accessible to the subsequent steps of beneficiation (particularly flotation and acid leaching).

A conventional mechanical comminution (crushing, grinding) does in fact also break the material at mechanical weak points, but because the inclusions in the case of natural quartz material are very small (a few micrometers) in comparison with the size of the processed quartz grains (20 mm), the mechanical weakening of the grain at the inclusion sites is not very pronounced, and the mechanical comminution occurs largely in a “blind” fashion.

The remaining granulate grains continue to contain solid and liquid-gaseous inclusions.

With the claimed comminution technology, the particular feature of the inner structure of natural quartz material (e.g., vein quartz) is taken into account and a highly pure granulate is obtained from the quartz material.

During the comminution by means of shock waves, the shock wave travels through the solid and discharges its energy at defects and phase boundaries, therefore particularly at inclusions. The material is broken up in this way from the inside out, proceeding from the inclusions. The fracture edges of the comminution run through the inclusions, so that at the end these inclusions lie on the surface of the granulate grains, which leads to a release of the foreign elements contained therein. This type of comminution is substantially more selective than a mechanical comminution by means of crushers and mills. The remaining granulate grains contain substantially fewer inclusions than would be the case in a purely mechanical comminution.

An embodiment of the method provides that a wet attrition cleaning is performed after the comminution of the pieces by means of high-voltage discharge pulses. In this case, a release of superficially bound foreign particles by mutual rubbing of the granulate grains and a flushing of the rubbed off particles occur.

A further quality improvement, i.e., a higher chemical purity of the granulate, can be achieved by carrying out a high gradient magnetic separation after the flotation to remove magnetic foreign particles.

As a result, the granulate grains arising in this manner no longer contain any or almost no inclusions, so that the content particularly of alkalis in the granulate can be considerably reduced, and also the formation of bubbles during the use of the granulate for a glass melt is substantially reduced.

It was possible to demonstrate experimentally that the content of alkali metals in the granulate can be decisively reduced with the method. The treatment of the same starting material produced the following results:

| Content in ppm | Li | Na |
|---|---|---|
| In the starting material | 1.5 | 4.0 |
| In the granulate, without high- | 0.9 | 2.4 |
| voltage pulse comminution | | |
| In the granulate, with high- | 0.4 | 0.8 |
| voltage pulse comminution | | |

The use of the high-voltage pulse comminution produced considerably better results in the case of other elements as well, such as Al, K, and Mg. Consequently, the use of the high-voltage pulse comminution has the result that the quartz granulate experiences the critical improvement in quality so that it can be used in the application segment for highly pure quartz sand.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a highly pure quartz granulate from natural quartz raw materials, the method comprising:
washing a natural quartz raw material provided in a form of coarsely pre-crushed pieces;
mechanically comminuting the pre-crushed pieces;
further comminuting the pieces via high-voltage discharge pulses to a grain size of less than 0.5 mm;
floating the pieces to separate foreign minerals; and
chemically treating the pieces for further depletion of foreign elements.

2. The method according to claim 1, wherein the washing of the raw materials is carried out with a high-pressure washing.

3. The method according to claim 1, wherein the mechanical comminution of the pre-crushed pieces to a grain size of 20 to 30 mm occurs.

4. The method according to claim 1, wherein a jaw crusher is used for the mechanical comminution of the pre-crushed pieces.

5. The method according to claim 1, wherein an optical sorting occurs after the mechanical comminution of the raw material.

6. The method according to claim 1, wherein a classification of the material occurs after the further comminution of the pieces via high-voltage discharge pulses.

7. The method according to claim 1, wherein an attrition cleaning is performed after the further comminution of the pieces.

8. The method according to claim 1, wherein a high gradient magnetic separation to remove magnetic foreign particles is carried out after the flotation.

9. The method according to claim 1, wherein the chemical treatment for further depletion of foreign elements occurs with a wet or dry acid leaching.

10. The method according to claim 1, wherein a high-temperature treatment or calcination of the granulate is carried out.
